(19) United States
(12) Patent Application Publication
(10) Pub. No.: US 2025/0287095 A1
(43) Pub. Date: Sep. 11, 2025

(54) DUAL MODE IMAGE SENSOR AND METHOD OF OPERATING IMAGE SENSOR AND RELATED ELECTRONIC DEVICE

(71) Applicant: Himax Imaging Limited, Tainan City (TW)

(72) Inventors: Yi-Chen Chou, Tainan City (TW); Tsung-Chi Chang, Tainan City (TW)

(73) Assignee: Himax Imaging Limited, Tainan City (TW)

(21) Appl. No.: 18/595,454

(22) Filed: Mar. 5, 2024

(51) Int. Cl. H04N 23/65; H04N 23/667; H04N 25/709

(52) U.S. Cl. CPC H04N 23/651; H04N 23/667; H04N 25/709

(57) ABSTRACT

An image sensor includes: a pixel array, a motion detection unit and a controller. The motion detection unit is configured to determine a motion state of a scene. The controller is configured to determine an operation mode of the image sensor according a level of a power voltage supplied to the image sensor, wherein the level of the power voltage is controlled according to the motion state determined by the motion detection unit. Additionally, the controller determines the image sensor to enter an image capturing mode if the power voltage has a high level and determines the image sensor to enter a motion detection mode if the power voltage has a low level.

### BACKGROUND OF THE INVENTION

### 1. Field of the Invention

The present invention relates to image sensors, and more particularly to an image sensor with dual operation modes, a method of operating an image sensor and a related electronic device.

### 2. Description of the Prior Art

The evolution of image recognition technology has experienced a significant transition from nascent explorations to a state of maturity, especially in applications within edge devices. These devices, ranging from smartphones and security cameras to sensors in autonomous vehicles and various wearable technologies, are now capable of conducting complex image analyses locally, all thanks to advancements in image recognition technology. With the rapid development of deep learning, neural networks, and machine learning algorithms, image recognition technology has moved beyond mere identification and classification of objects in images. It now delves into more intricate analyses such as emotion detection, behavior prediction, and even sophisticated medical image diagnostics. However, a key challenge arises in ensuring the sustained operation of image sensors in image recognition systems without depleting the limited power resources of edge devices. Image sensors, essential for continuously capturing image data, pose a significant challenge to power consumption due to their “always on” mode of operation.

### SUMMARY OF THE INVENTION

With this in mind, it is one object of the present invention to provide an image sensor with dual operation modes and a method of operating an image sensor. Embodiments of the present invention rely on motion detection to determine whether to change an operation mode of the image sensor. The present invention not only enhances the power efficiency of the image sensor but also ensures the maintenance of high image quality. Subsequently, such improvements in operational efficiency and image fidelity directly contribute to enhanced accuracy of image recognition.

According to one embodiment, an image sensor is provided. The image sensor comprises: a pixel array, a motion detection unit and a controller. The motion detection unit is configured to determine a motion state of a scene. The controller is configured to determine an operation mode of the image sensor according a level of a power voltage supplied to the image sensor, wherein the level of the power voltage is controlled according to the motion state determined by the motion detection unit. Additionally, the controller determines the image sensor to enter an image capturing mode if the power voltage has a high level and determines the image sensor to enter a motion detection mode if the power voltage has a low level.

According to one embodiment, a method of operating an image sensor is provided. The method comprises: performing motion detection to determine a motion state of a scene; controlling a level of a power voltage supplied to the image sensor according to the motion state; determining the image sensor to enter an image capturing mode if the power voltage has a high level; and determining the image sensor to enter a motion detection mode if the power voltage has a low level.

According to one embodiment, an electronic device is provided. The electronic device comprises an image sensor and a processing unit. The image sensor comprises: a pixel array, a motion detection unit and a controller. The motion detection unit is configured to determine a motion state of a scene. The controller is configured to determine an operation mode of the image sensor according a level of a power voltage supplied to the image sensor, wherein the level of the power voltage is controlled according to the motion state determined by the motion detection unit. The controller determines the image sensor to enter an image capturing mode if the power voltage has a high level and determines the image sensor to enter a motion detection mode if the power voltage has a low level. The processing unit is configured to perform image recognition processing according to one or more captured image generated by the image sensor.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic diagram of an image sensor and a related electronic device according to one embodiment of the present invention.

FIG. 2 illustrates relationship between a level of the power voltage and an operation mode of an image sensor according to one embodiment of the present invention.

FIG. 3 illustrates a state machine diagram of an image sensor according to one embodiment of the present invention.

FIG. 4 illustrates a flow chart a method of operating an image sensor according to one embodiment of the present invention.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

The singular forms “a,” “an” and “the” include plural referents unless the context clearly dictates otherwise. Reference throughout this specification to “one embodiment” or “an embodiment” means that a particular feature, structure, or characteristic described in connection with the embodiment is included in at least one embodiment of the present disclosure. Therefore, the appearances of the phrases “in one embodiment” or “in an embodiment” in various places throughout this specification are not necessarily all referring to the same embodiment. Further, the particular features, structures, or characteristics may be combined in any suitable manner in one or more embodiments.

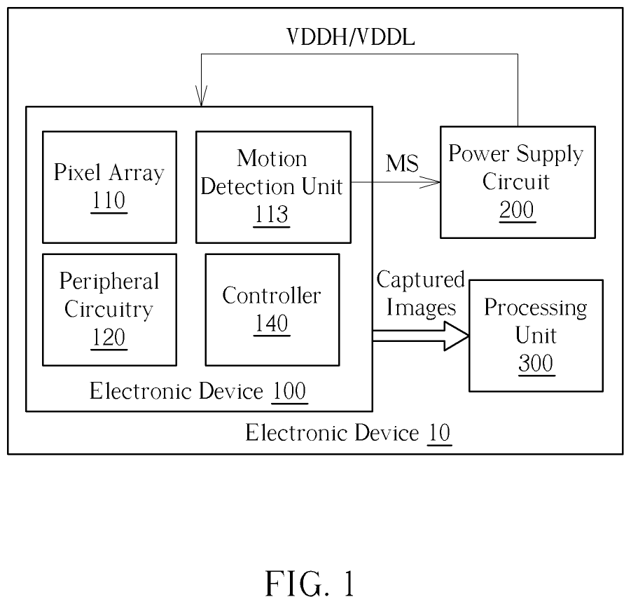

Please refer to FIG. 1, which illustrates a schematic diagram of an image sensor and a related electronic device according to one embodiment of the present invention. As illustrated, an electronic device 10 comprises an image sensor 100, a power supply circuit 200 and a processing unit 300.

In one embodiment, the electronic device 10 could be an edge device for performing various types of image recognition, such as facial recognition for security systems, object detection for autonomous driving, gesture recognition for interactive applications, and scene analysis for smart surveillance systems. Examples of the electronic device 10 include smartphones, wearable devices like smart glasses or smart watches, embedded systems in vehicles, drones equipped with cameras, digital cameras with AI capabilities or smart home devices such as security cameras.

The image sensor 100 of the electronic device 10 is configured to capture a scene to generate high-quality captured images. The processing unit 300 of the electronic device 10 is configured to execute various kinds of algorithms or machine-learning methods, such as convolution neural network (CNN), recurrent neural networks (RNN), support vector machines (SVM), decision trees, or advanced object detection frameworks like You Only Look Once (YOLO) and single shot multiBox detector (SSD) to analyze the high-quality captured images to achieve image recognition.

The image sensor 100 is powered by the external power supply circuit 200. The power supply circuit 200 is configured to supply electrical power to the image sensor 100. Specifically, a level of a power voltage supplied by the power supply circuit 200 to the image sensor 100 may be associated with operations mode of the image sensor 100. In one embodiment, the power voltage has a high level VDDH and a low level VDDL. If the power voltage supplied to the image sensor 100 is at the high level VDDH, the image sensor 100 could enter an image capturing mode, which consumes higher power. If the power voltage supplied to the image sensor 100 is at the low level VDDL, the image sensor 100 could enter a motion detection mode, which consumes less power. In one embodiment, the high quality captured images for image recognition only be generated by the image sensor 100 during the image capturing mode.

In one embodiment, the power supply circuit 200 may comprise power rails and/or energy banks. In one embodiment, the power rails may be voltage buses at levels such as 3V, 2.4V, or other voltage levels. In one embodiment, the energy banks may be capacitors, batteries, or any types of energy storage units. In one embodiment, the power supply circuit 200 may further comprise voltage conversion devices to produce a stable and regulated power voltage at high level VDDH and low level VDDL for the image sensor 100. According to various embodiments of the present invention, the voltage conversion devices may be voltage regulators, switching power converters, low-dropout regulators, integrated voltage regulators, or any kind of voltage conversion circuits.

The image sensor 100 comprises a pixel array 110, a peripheral circuitry 120, a motion detection unit 130 and a controller 140. The pixel array 110 comprises a plurality of pixel circuits that are organization in a matrix configuration, which encompasses N rows and M columns. According to various embodiments of the present invention, the pixel array 110 may capture RGB color information, YUV (luminance and chrominance) color information or WRGB information.

The peripheral circuitry 120 is configured to read signals to provide one or more captured images or one or more detection images by detecting charges sensed on the pixel circuits of the pixel array 110. During the image capturing mode, the peripheral circuitry 120 may read signals from all pixel circuits of the pixel array 110 to generate the one or more captured images with high-resolution (e.g. M×N) and full color information. During the motion detection mode, the peripheral circuitry 120 may read signals from specific pixel circuits of the pixel array 110 to generate the one or more detection images with low-resolution (e.g. (M/k)×(N/1)) and reduced color information. In one embodiment, the peripheral circuitry 120 may read signals only from specific rows and/or specific columns of pixel circuits of the pixel array 110 or from pixel circuits to thereby generate the one or more detection images with low-resolution. In one embodiment, the peripheral circuitry 120 may read signals only from specific ones of pixel circuits of the pixel array 110 corresponding to a specific one or more luminance or color information/channel. For example, the peripheral circuitry 120 may read signals only from pixel circuits corresponding to Y (luminance) information, W (white) information (for RGBW pixel configuration) or only one of RGB information (for RGB pixel configuration). According to various embodiments of the present invention, the peripheral circuitry may 120 comprise readout circuits, analog-to-digital converters, sensing amplifiers, auto exposure and white balance control circuits, autofocus control circuits and signal processing circuits.

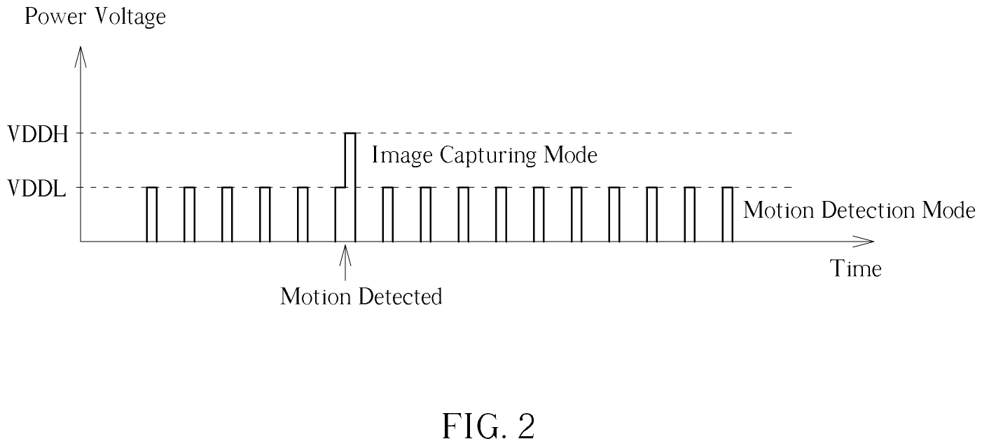

The motion detection unit 130 is configured detect a motion of the scene that the image sensor 100 and the electronic device 10 are applied to. The motion detection unit 130 determines a motion state of the scene indicative of whether the scene has motion (or is dynamic) or is motionless (or still). Accordingly, the motion detection unit 130 generates an indication signal MS reflecting the determined motion state to the power supply circuit 200. Based on the indication signal MS, the power supply circuit 200 controls the level of the power voltage. Please refer to FIG. 2 for further understands. As illustrated, if the motion state indicates the scene is motionless (or still), the power supply circuit 200 generates the power voltage at the low level VDDL, allowing the controller 140 to determine the image sensor 100 to enter the motion detection mode. On the other hand, once the motion state indicates the scene has motion (or is dynamic), the power supply circuit 200 generates the power voltage at the high level VDDH, allowing the controller 140 to determine the image sensor 100 to enter the image capturing mode.

In some embodiments, the motion detection unit 130 is periodically enabled or enters a normal operation mode, which means the motion detection performed by the motion detection unit 130 is periodical. Each time after the motion detection unit 130 performs the motion detection to determine a current motion state, the motion detection unit 130 will be disabled or enters a sleep mode for a while. In the meantime, the power supply circuit 200 may stop providing the power voltage if the motion detection unit 130 is disabled or enters the sleep mode. In one embodiment, the motion detection unit 130 will be disabled or enters the sleep mode if the controller 140 determines the image sensor 100 to enter the image capturing mode in response to receiving the power voltage at VDDH (since motion detection is unnecessary for this moment).

The motion detection unit 130 determines the motion state of the scene according to the one or more detection images with low-resolution and/or reduced color information provided by the peripheral circuitry 120. Specifically, the motion detection unit 130 could determine the motion state of the scene according to a change rate of luminance of pixels in the one or more detection images. If there is a moving object, movement, or significant change in scene composition, existing in the one or more detection images, the change rate of luminance of pixels would reach a threshold, allowing the motion detection unit 130 to determine the scene has motion (or is dynamic).

According to various embodiments of the present invention, the motion detection unit 130 could determine the motion state of the scene according to the change rate of luminance of specific pixels (i.e., region of interest (ROI)) in the one or more detection images. According to various embodiments of the present invention, the motion detection unit 130 could determine the scene has motion (or is dynamic) only when the change rate of luminance of a specific number of pixels in the one or more detection images reaches the threshold.

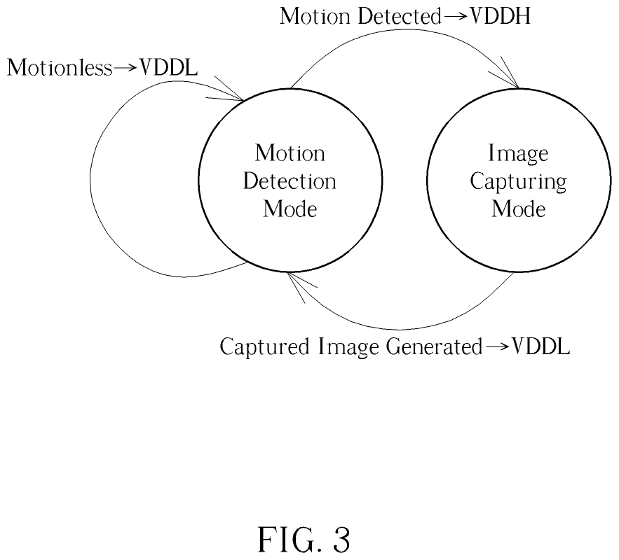

FIG. 3 illustrates a state machine diagram of the image sensor 100 according to one embodiment of the present invention. The controller 140 would determine the image sensor 100 to stay in the motion detection mode if the motion state indicates the scene is motionless (since the level of the power voltage is currently VDDL). Further, the controller 140 would determine the image sensor 100 to leave the motion detection mode and enter the image capturing mode once the motion state indicates the scene has motion (or is dynamic) since the level of the power voltage is currently VDDH. On the hand, the controller 140 would determine the image sensor 100 to leave the image capturing mode and enter the motion detection mode once the one or more captured images with high-resolution and full color information are generated for the processing unit 300. In response to leaving the image capturing mode, the power supply circuit 200 would lower the level of the power voltage from VDDH to VDDL.

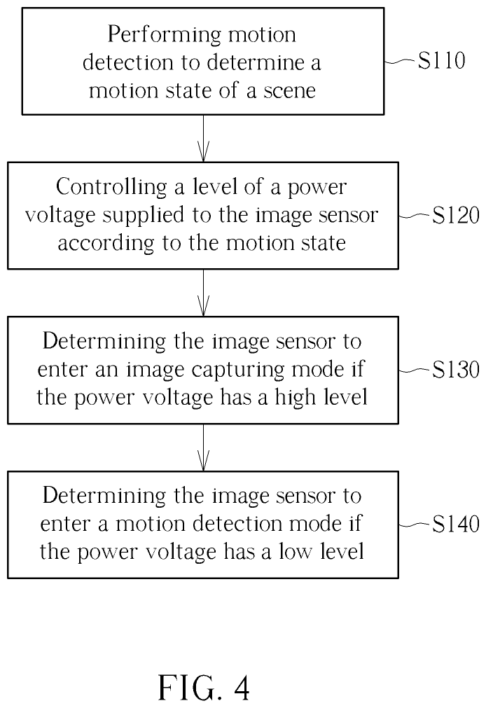

Based on the above descriptions, FIG. 4 illustrates a flow chart a method of operating an image sensor according to one embodiment of the present invention. As shown, the flow includes the following simplified steps:
Step S110: performing motion detection to determine a motion state of a scene; and
Step S120: controlling a level of a power voltage supplied to the image sensor according to the motion state;
Step S130: determining the image sensor to enter an image capturing mode if the power voltage has a high level; and
Step S140: determining the image sensor to enter a motion detection mode if the power voltage has a low level.

The principles and specific details of the above steps have been thoroughly explained through previous embodiments and are not reiterated here. It should be noted that the aforementioned flow can be enhanced by adding additional steps or through appropriate modifications and adjustments to improve the power efficiency and image quality of the image sensor.

Embodiments in accordance with the present embodiments can be implemented as an apparatus, method, or computer program product. Accordingly, the present embodiments may take the form of an entirely hardware embodiment, an entirely software embodiment, or an embodiment combining software and hardware aspects that can all generally be referred to herein as a “module” or “system.” Furthermore, the present embodiments may take the form of a computer program product embodied in any tangible medium of expression having computer-usable program code embodied in the medium. In terms of hardware, the present invention can be accomplished by applying any of the following technologies or related combinations: an individual operation logic with logic gates capable of performing logic functions according to data signals, and an application specific integrated circuit (ASIC), a programmable gate array (PGA) or a field programmable gate array (FPGA) with a suitable combinational logic.

The flowchart and block diagrams in the flow diagrams illustrate the architecture, functionality, and operation of possible implementations of systems, methods, and computer program products according to various embodiments of the present embodiments. In this regard, each block in the flowchart or block diagrams may represent a module, segment, or portion of code, which comprises one or more executable instructions for implementing the specified logical function(s). It is also noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions. These computer program instructions can be stored in a computer-readable medium that directs a computer or other programmable data processing apparatus to function in a particular manner, such that the instructions stored in the computer-readable medium produce an article of manufacture including instruction means which implement the function/act specified in the flowchart and/or block diagram block or blocks.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An image sensor, comprising:
a pixel array;
a motion detection unit configured to determine a motion state of a scene; and
a controller configured to determine an operation mode of the image sensor according a level of a power voltage supplied to the image sensor, wherein the level of the power voltage is controlled according to the motion state determined by the motion detection unit;
wherein the controller determines the image sensor to enter an image capturing mode if the power voltage has a high level and determines the image sensor to enter a motion detection mode if the power voltage has a low level.

2. The image sensor of claim 1, wherein a power supply circuit is configured to generate the power voltage; the power supply circuit generates the power voltage at the high level if the motion state indicates the scene has motion or is dynamic, and the power supply circuit generates the power voltage at the low level if the motion state indicates the scene is motionless or still.

3. The image sensor of claim 1, further comprising:
a peripheral circuitry configured to read signals from the pixel array and accordingly generate one or more captured images or one or more detection images according to the operation mode determined by the controller;
wherein the motion detection unit is configured to determine the motion state according to the one or more detection images generated by the peripheral circuitry.

4. The image sensor of claim 3, wherein the peripheral circuitry is configured to generate the one or more detection images if the controller determines the image sensor to enter the motion detection mode; and the peripheral circuitry is configured to generate the one or more captured images if the controller determines the image sensor to enter the image capturing mode.

5. The image sensor of claim 3, wherein the peripheral circuitry is configured to read signals from specific ones of pixel circuits of the pixel array to generate the one or more detection images;
and the specific ones of pixel circuits includes pixel circuits of one or more specific rows and/or columns of the pixel array or pixel circuits corresponds to one specific one or more luminance or color information/channels.

6. The image sensor of claim 3, wherein the peripheral circuitry is configured to read signals from all pixel circuits of the pixel array to generate the one or more captured images.

7. The image sensor of claim 1, wherein the motion detection unit is enabled or enters a normal operation mode periodically and is disabled or enters a sleep mode after determining the motion state.

8. The image sensor of claim 1, wherein the motion detection unit is disabled or enters a sleep mode in response to determining that the image sensor enters the image capturing mode.

9. The image sensor of claim 1, wherein the controller determines the image sensor to enter the motion detection mode after generating one or more captured images during the image capturing mode.

10. A method of operating an image sensor, comprising:
performing motion detection to determine a motion state of a scene;
controlling a level of a power voltage supplied to the image sensor according to the motion state;
determining the image sensor to enter an image capturing mode if the power voltage has a high level; and
determining the image sensor to enter a motion detection mode if the power voltage has a low level.

11. The method of claim 10, further comprising:
utilizing a power supply circuit to generate the power voltage;
controlling the power supply circuit to generate the power voltage at the high level if the motion state indicates the scene has motion or is dynamic; and
controlling the power supply circuit to generate the power voltage at the low level if the motion state indicates the scene is motionless or dynamic.

12. The method of claim 10, further comprising:
reading signals from a pixel array of the image sensor and accordingly generating one or more captured images or one or more detection images according to an operation mode of the image sensor; and
determining the motion state according to the one or more detection images.

13. The method of claim 12, wherein the step of generating the one or more captured images or the one or more detection images comprises:
generating the one or more detection images in response to determining the image sensor to enter the motion detection mode; and
generating the one or more captured images in response to determining the image sensor to enter the image capturing mode.

14. The method of claim 12, wherein the step of reading the signals from the pixel array of the image sensor comprises:
reading signals from specific ones of pixel circuits of the pixel array to generate the one or more detection images;
wherein the specific ones of pixel circuits includes pixel circuits of one or more specific rows and/or columns of the pixel array or pixel circuits corresponds to one specific one or more luminance or color information/channels.

15. The method of claim 12, wherein the step of reading the signals from the pixel array of the image sensor comprises:
reading signals from all pixel circuits of the pixel array to generate the one or more captured images.

16. The method of claim 10, further comprising:
enabling a motion detection unit for performing the motion detection or allowing the motion detection unit to enter a normal operation mode periodically; and
disabling the motion detection unit or allowing the motion detection unit to enter a sleep mode after determining the motion state.

17. The method of claim 10, further comprising:
disabling a motion detection unit for performing the motion detection or allowing the motion detection unit to enter a sleep mode in response to determining that the image sensor enters the image capturing mode.

18. The method of claim 10, further comprising:
determining the image sensor to enter the motion detection mode in response to that the image sensor generates one or more captured images during the image capturing mode.

19. An electronic device, comprising:
an image sensor, comprising:
a pixel array;
a motion detection unit configured to determine a motion state of a scene; and
a controller configured to determine an operation mode of the image sensor according a level of a power voltage supplied to the image sensor, wherein the level of the power voltage is controlled according to the motion state determined by the motion detection unit;
wherein the controller determines the image sensor to enter an image capturing mode if the power voltage has a high level and determines the image sensor to enter a motion detection mode if the power voltage has a low level;
a processing unit, configured to perform image recognition processing according to one or more captured image generated by the image sensor.
